(19) United States
(12) Patent Application Publication
(10) Pub. No.: US 2026/0296438 A1
(43) Pub. Date: Oct. 1, 2026

(54) AUTONOMOUS DRIVING SYSTEM AND CONTROL METHOD THEREFOR

(71) Applicants: Hyundai Motor Company, Seoul (KR); Kia Corporation, Seoul (KR)

(72) Inventors: Jae Min JANG, Hwaseong-Si (KR); Young Bin MIN, Hwaseong-Si (KR); Jong Sung PARK, Hwaseong-Si (KR); Moon Hyung SONG, Hwaseong-Si (KR)

(21) Appl. No.: 19/391,052

(22) Filed: Nov. 17, 2025

(30) Foreign Application Priority Data
Mar. 31, 2025 (KR) 10-2025-0041289

(51) Int. Cl. B60W 30/18; B60W 50/00; B60W 50/038; B60W 50/14; B60W 60/00

(52) U.S. Cl. CPC B60W 30/18163; B60W 50/0097; B60W 50/038; B60W 50/14; B60W 60/0015; B60W 60/0054; B60W 2710/18

(57) ABSTRACT

A method for controlling an autonomous driving system for a vehicle, the method comprises: obtaining, from a sensor of the vehicle, information on the vehicle and a surrounding environment of the vehicle; identifying an operational design domain (ODD) departure event of the vehicle based on the information, wherein the ODD corresponds to a set of operating conditions under which autonomous driving of the vehicle is designed to function; determining a type of the ODD departure event, based on at least one of a location associated with the ODD departure event or a predictability of the ODD departure event; and controlling, based on the type of the ODD departure event, driving of the vehicle.

### CROSS-REFERENCE TO RELATED APPLICATION

This application claims the benefit of priority to Korean Patent Application No. 10-2025-0041289, filed in the Korean Intellectual Property Office on Mar. 1, 2025, the entire contents of which are incorporated herein by reference.

### TECHNICAL FIELD

The present disclosure relates to an autonomous driving system and a control method therefor.

### BACKGROUND

The matters described in this Background section are only for enhancement of understanding of the background of the disclosure, and should not be taken as acknowledgment that they correspond to prior art already known to those skilled in the art.

Advanced driver assistance systems, such as autonomous driving systems, are being developed to assist drivers with the operation of a vehicle. Unlike autonomous driving on regular roads, highway autonomous driving exhibits distinct characteristics due to the absence of intersections, traffic lights, and pedestrians, and the relatively steady traffic flow on highways contributes to more predictable road conditions than on regular roads.

Highways provide a comparatively favorable environment for deploying various autonomous driving technologies, such as Lane Keeping Assist Systems (LKAS) for controlling a vehicle to stay in its lane during driving, Adaptive Cruise Control (ACC) for automatically adjusting the speed to maintain a distance from vehicles ahead, and Automatic Lane Change Systems (ALCS) for automatically changing lanes based on real-time road conditions.

Autonomous driving systems are required to determine in real time whether the vehicle remains within its operational design domain (ODD) during driving, while also determining the likelihood of departure from that domain in real time. Whether the vehicle remains within its operational design domain, as well as the likelihood of departure from that domain, may be determined differently depending on the vehicle’s status and the conditions of its surrounding environment. A method for determining a type and a degree of risk associated with the ODD departure event and ensure safe vehicle control based on the type and the degree of risk is considered.

### SUMMARY

In view of the above, the present disclosure is directed to solving the foregoing problems, and a primary object of the present disclosure is to provide a method for determining the type and degree of risk associated with the ODD departure event.

Another primary object of the present disclosure is to provide a method for variably controlling a vehicle according to the type and degree of risk associated with the ODD departure event.

The examples of the present disclosure are not limited to the foregoing, and other examples not mentioned herein will be able to be clearly understood by those skilled in the art from the following description.

According to the present disclosure, a method performed by an apparatus of a vehicle may comprise obtaining, from a sensor of the vehicle, information on the vehicle and a surrounding environment of the vehicle, identifying an operational design domain (ODD) departure event of the vehicle based on the information, wherein the ODD corresponds to a set of operating conditions under which autonomous driving of the vehicle is designed to function, determining a type of the ODD departure event based on at least one of a location associated with the ODD departure event or a predictability of the ODD departure event, and controlling, based on the type of the ODD departure event, driving of the vehicle.

The method may further comprise determining a degree of risk associated with the ODD departure event based on at least one of the type of the ODD departure event or whether or not the ODD departure event is predictable. Based on the ODD departure event being predictable, the degree of risk may be determined based on at least one of a remaining distance for the vehicle to reach the location, a remaining time for the vehicle to reach the location, or a presence or absence of a safety zone within a threshold distance from the location, and based on the ODD departure event not being predictable, the degree of risk may be determined based on at least one of an intensity of the ODD departure event, a duration of the ODD departure event, or a frequency of the ODD departure event.

The method may further comprise determining a degree of risk associated with the ODD departure event based on the type of the ODD departure event, wherein the controlling of driving of the vehicle may comprise performing at least one of a control operation for limiting driving performance of the vehicle, a control operation for requesting a passenger to perform a dynamic driving task (DDT), or a minimal risk maneuver (MRM) control operation.

Based on the degree of risk being lower than a risk threshold value and based on at least one of a remaining time for the vehicle to reach the location being equal to or greater than a time threshold value or a remaining distance for the vehicle to reach the location being equal to or greater than a distance threshold value, the control operation for limiting the driving performance of the vehicle may be performed.

Based on at least one of the degree of risk being higher than a risk threshold value, a remaining time for the vehicle to reach the location being less than a time threshold value, or a remaining distance for the vehicle to reach the location being less than a distance threshold value, at least one of the control operation for requesting the passenger to perform the DDT or the MRM control operation may be performed.

The control operation for limiting the driving performance of the vehicle may comprise at least one of a control operation for limiting a maximum speed of the vehicle, a control operation for limiting a maximum revolutions per minute (RPM) of the vehicle, or a control operation for limiting low-level autonomous driving functions of the vehicle.

The type of the ODD departure event may comprise a first type which occurs at a fixed location and is predictable, a second type which occurs at a fixed location and is not predictable, a third type which occurs at an unfixed location and is not predictable, and a fourth type which occurs at an unfixed location and is predictable.

The method may further comprise determining a degree of risk associated with the ODD departure event, wherein the type of the ODD departure event comprises a first type which occurs at a fixed location and is predictable, and wherein, based on the ODD departure event corresponding to the first type, the degree of risk may be determined as low before the vehicle has reached the fixed location and determined as high after the vehicle has reached the fixed location.

Based on the degree of risk being determined as low, the controlling of driving of the vehicle may comprise performing a control operation for requesting a passenger to perform a dynamic driving task (DDT), and based on the degree of risk being determined as high, the controlling of driving of the vehicle may comprise performing shoulder stop control using a minimal risk maneuver (MRM).

The method may further comprise determining a degree of risk associated with the ODD departure event, wherein the type of the ODD departure event comprises a second type which occurs at a fixed location and is not predictable, and wherein, based on the ODD departure event corresponding to the second type, the degree of risk may be determined based on at least one of a perception failure rate associated with recognizing the surrounding environment of the vehicle, a control error rate associated with deviations between a target driving status of the vehicle and an actual driving status of the vehicle, or a duration of the ODD departure event.

Based on the ODD departure event corresponding to the second type, the degree of risk may be determined as low based on the perception failure rate, the control error rate, and the duration being within respective threshold limits, the degree of risk may be determined as intermediary based on one of the perception failure rate, the control error rate, or the duration exceeding the respective threshold limits, and the degree of risk may be determined as high based on at least two of the perception failure rate, the control error rate, and the duration exceeding the respective threshold limits.

Based on the degree of risk being determined as low or intermediary, the controlling of driving of the vehicle may comprise performing at least one of a control operation for requesting a passenger to perform a dynamic driving task (DDT) and a control operation for limiting driving performance of the vehicle, and based on the degree of risk being determined as high, the controlling of the vehicle may comprise performing an in-lane stop control or a straight stop control using a minimal risk maneuver (MRM).

The method may further comprise determining a degree of risk associated with the ODD departure event, wherein the type of the ODD departure event comprises a third type which occurs at an unfixed location and is not predictable, wherein, based on the ODD departure event corresponding to the third type, the degree of risk may be determined based on at least one of a perception failure rate associated with recognizing the surrounding environment of the vehicle, a control error rate associated with deviations between a target driving status of the vehicle and an actual driving status of the vehicle, a duration of the ODD departure event, or a frequency of the ODD departure event.

Based on the ODD departure event corresponding to the third type, the degree of risk may be determined as low based on the perception failure rate, the control error rate, the duration, and the frequency being within respective threshold limits, the degree of risk may be determined as intermediary based on one of the perception failure rate, the control error rate, the duration, or the frequency exceeding the respective threshold limits, and the degree of risk may be determined as high based on at least two of the perception failure rate, the control error rate, the duration, or the frequency exceeding the respective threshold limits.

Based on the degree of risk being determined as low or intermediary, the controlling of driving of the vehicle may comprise performing at least one of a control operation for requesting a passenger to perform a dynamic driving task (DDT) and a control operation for limiting driving performance of the vehicle, and based on the degree of risk being determined as high, the controlling of driving of the vehicle may comprise performing an in-lane stop control or a straight stop control using a minimal risk maneuver (MRM).

The method may further comprise determining a degree of risk associated with the ODD departure event, wherein the type of the ODD departure event comprises a fourth type which occurs at an unfixed location and is predictable, wherein, based on the ODD departure event corresponding to the fourth type, the degree of risk may be determined as low before the vehicle has reached the unfixed location and determined as high after the vehicle has reached the unfixed location.

Based on the degree of risk being determined as low, the controlling of driving of the vehicle may comprise performing a control operation for requesting a passenger to perform a dynamic driving task (DDT), and based on the degree of risk being determined as high, the controlling of driving of the vehicle may comprise performing a shoulder stop control or an in-lane stop control using a minimal risk maneuver (MRM). The method may further comprise, based on the ODD departure event ending, discontinuing a control operation for limiting driving performance of the vehicle which was triggered by the ODD departure event, and restoring the driving performance of the vehicle.

A vehicle may comprise a sensor, a driving control circuit configured to control autonomous driving of the vehicle, and a processor circuit configured to obtain, based on data from the sensor, information on the vehicle and a surrounding environment of the vehicle, identify an operational design domain (ODD) departure event corresponding to an event that causes or is expected to cause the vehicle or the surrounding environment to fall outside the ODD, wherein the ODD corresponds to a set of operating conditions under which autonomous driving of the vehicle is designed to function, based on at least one of a location associated with the ODD departure event or a predictability of the ODD departure event, determine a type of the ODD departure event, determine, based on the type of the ODD departure event, a degree of risk associated with the ODD departure event, and control, via the driving control circuit and based on the degree of risk, driving of the vehicle by performing at least one of requesting driver takeover, adjusting a level of autonomous driving, or executing a minimal risk maneuver.

As explained above, according to an example of the present disclosure, an autonomous driving system is capable of determining the type of an ODD departure event in relation to the boundaries of the ODD and the degree of risk associated with the ODD departure event.

Furthermore, it is possible to variably control the vehicle according to the type of the ODD departure event in relation to the boundaries of an ODD and the degree of risk associated with the ODD departure event.

### BRIEF DESCRIPTION OF THE DRAWINGS

FIG. 1 shows an example of an autonomous driving system.

FIG. 2 shows an example of a control method for an autonomous driving system.

FIG. 3 shows an example of a toll gate on the road where the vehicle is driving.

FIG. 4 shows an example of a pothole on the road where the vehicle is driving.

FIG. 5 shows an example of a road scene where the vehicle is driving in the rain.

FIG. 6 shows an example of a roadwork site on the road where the vehicle is driving.

FIG. 7 shows an example of a toll gate, a pothole, and a roadwork site on the road where the vehicle is driving in the rain.

FIG. 8 shows an example of types of ODD departure events.

FIG. 9 shows an example of a straight stop.

FIG. 10 shows an example of an in-lane stop.

FIG. 11 shows an example of a half-shoulder stop.

FIG. 12 shows an example of a full-shoulder stop.

FIG. 13 shows an exemplary vehicle system that can be used to implement a method or apparatus described in the present disclosure.

### DETAILED DESCRIPTION

Hereinafter, some examples of the disclosure will be described in detail with reference to exemplary drawings. In assigning reference numerals to the components of each drawing, it should be noted that the same numerals are used for the same components, as much as possible, even if they are shown in different drawings. In addition, in describing the disclosure, if it is determined that a specific description of a related known configuration or function may obscure the gist of the disclosure, the detailed description thereof will be omitted. In describing the components of the disclosure, the terms “first,” “second,” “A,” “B,” “(a),” “(b),” and the like may be used. These terms are only used to distinguish the components from other components, and the nature, sequence, order, or the like of the components is not limited by these terms.

When a component is described as being “connected,” “coupled,” or “connected” to other component, it should be understood that the component may be directly connected or connected to the other component, but another component may also be “connected,” “connected,” or “coupled” between each component.

Throughout the specification, when a part is referred to as "including" or "comprising" a component, it means that, unless specifically stated otherwise, the part may further include other components instead of excluding the other components.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”. In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

Unless otherwise stated, it should be understood that the description of any one example may be applied to other examples as well. The description to be disclosed below in connection with the accompanying drawings is intended to describe examples of the disclosure and is not intended to represent the only examples in which the disclosure may be practiced. The terms used in the present disclosure may be defined as follows.

The term “vehicle” refers to a vehicle that is equipped with an ADS (automated driving system or autonomous driving system) and capable of autonomous driving. For example, a vehicle is capable of performing at least one of steering, acceleration, deceleration, lane change, braking, and stopping, without the driver’s manipulation, through the use of an ADS. The autonomous driving system may include, for example, at least one of PDCMS (Pedestrian Detection and Collision Mitigation System), LCDAS (Lane Change Decision Aid System), LDWS (Land Departure Warning System), ACC (Adaptive Cruise Control), LKAS (Lane Keeping Assistance System), RBDPS (Road Boundary Departure Prevention System), CSWS (Curve Speed Warning System), FVCWS (Forward Vehicle Collision Warning System), and LSF (Low Speed Following).

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

The terms “passenger”, “user”, and “driver” all refer to human beings who utilize the vehicle and receive services from an autonomous driving system.

The term “authority over vehicle control” or “vehicle control authority” refers to the authority to control at least one component of the vehicle and/or at least one function of the vehicle. Vehicle functions may include at least one of steering, acceleration, deceleration, braking, lane change, line detection, lateral control, object (or obstacle) detection and distance sensing, powertrain control, safe area sensing, engine on/off, power on/off, and vehicle lock/unlock. The vehicle functions listed are provided solely as illustrative examples to aid understanding, and the examples of the present disclosure are not limited to these examples.

The term “lane” refers to part of a roadway over which vehicles travel, separated by markings, that is intended for a single line of vehicles. The term “current lane” refers to the lane in which a vehicle is currently traveling in real time. For example, if a vehicle is traveling in lane 2, then lane 2 is considered to be the current lane of the vehicle.

The term “adjacent lane” refers to a lane that is directly next to the current lane. For example, if a vehicle is currently driving in lane 1 on a multi-lane road, its adjacent lane may be lane 2. Similarly, if a vehicle is currently driving in lane 2, its adjacent lane may be lane 3.

The term “entire lanes” refers to all the individual lanes – from lane 1 to the outermost lane. For example, on a three-lane road, the entire lanes may include lane 1, lane 2, and lane 3.

The term “line” refers to a line that separates different lanes. For example, on a road with four lanes and four lines, line 1 separates lane 1 and lane 2, line 2 separates lane 2 and lane 3, line 3 separates lane 3 and lane 4, and line 4 separates lane 4 and a shoulder.

The term “shoulder” refers to an edge of land along a roadway. The shoulder may serve as an emergency stopping lane for vehicles, and may also be used by emergency vehicles such as ambulances or police cars to bypass traffic. As used herein, the term “shoulder” may encompass safety zones and other designated areas such as rest areas and pocket lanes.

The term “dynamic driving task (hereinafter, “DDT”) may refer to a concept that encompasses all the operational functions needed to operate a vehicle during driving. DDT includes physical manipulations such as steering, acceleration, and deceleration, and also may include tasks such as perceiving and interpreting the surrounding environment of the vehicle, cognitive tasks such as planning a driving route and obeying traffic rules, and decision-making tasks. DDT may encompass tasks like monitoring the vehicle’s status, the vehicle’s surrounding environment, road conditions, etc., in real time and properly responding to situations.

Autonomous driving levels and modes describe the extent to which DDT is performed by the human driver versus the autonomous driving system.

Autonomous Driving Levels 1 to 4 require the human driver to perform DDT and intervene while the autonomous driving system is operating. For example, at Autonomous Driving Level 2, the autonomous driving system performs acceleration, deceleration, and steering, but the driver is still responsible for monitoring the entire DDT and remaining engaged.

At Autonomous Driving Level 5, the autonomous driving system handles the entire DDT, and there is no need for the driver’s intervention.

The term “operational design domain (hereinafter, “ODD”) refers to the specific operational conditions under which an autonomous driving system is designed or configured to function. ODD may include various conditions required to perform autonomous driving features, such as driving environment, weather conditions, time of day, traffic conditions, roadway types, vehicle speed, the vehicle’s proper functioning, and so on.

The term “actual operating conditions” or “actual conditions” refers to all conditions affecting the surrounding environment of a vehicle that performs autonomous driving. That is, the concept of actual conditions encompasses the circumstances under which an autonomous driving system is operating, such as weather, geography, time of day, traffic conditions, roadway shapes, nearby vehicles, etc. In other words, the actual conditions may refer to all conditions a vehicle encounters while autonomous driving is active. The autonomous driving system 100 may determine the actual operating conditions by sensing the vehicle and its surroundings using sensors. That is, the autonomous driving system 100 may obtain information on the surrounding environment of the vehicle by using sensors.

The status of the vehicle may denote its current operational condition, including whether the vehicle is properly functioning or experiencing a fault. The autonomous driving system 100 may determine the status of the vehicle based on signals received from the sensor unit 110 and signals received from each of the components.

The autonomous driving system 100 may determine in real time whether the vehicle remains within its ODD while the vehicle is driving autonomously.

Several examples of a vehicle failing to remain within its ODD will be described.

In all cases where at least one of various functions of the vehicle cannot be performed due to an internal factor of the vehicle and/or an external factor of the vehicle, the vehicle may fail to remain within its ODD.

In all cases where at least one of various functions of the vehicle cannot be performed due to an internal factor of the vehicle and/or an external factor of the vehicle, in all cases where at least one of functions related to vehicle driving cannot be performed, and in all cases where the vehicle is not able to drive at all, the vehicle may fail to remain within its ODD.

For example, if the vehicle and/or the actual conditions fail to remain within the ODD, this may mean that a malfunction has occurred to at least one of various features of the vehicle. For example, if a malfunction has occurred to at least one of steering, acceleration, deceleration, braking, stopping, lane change, lane and line detection, lateral control, object (or obstacle) detection and distance sensing, current location measurement, powertrain control, safe area detection, engine on/off, power on/off, vehicle lock/unlock, communication, and autonomous driving, the autonomous driving system 100 may determine that the vehicle falls outside the ODD.

For example, if the surrounding environment of the vehicle changes while the vehicle and/or the actual conditions remain within the ODD, the vehicle and/or the actual conditions may fall outside the ODD. For example, the autonomous driving system 100 may determine that the vehicle and/or the actual conditions fall outside the ODD, when object detection via sensors becomes infeasible due to weather conditions (e.g., heavy snow, heavy rain, thick fog, backlighting, or extreme temperatures) or such conditions impair the proper functioning of the sensors, when a road is damaged due to a sinkhole or a natural disaster (e.g., avalanche and flooding) or is otherwise in an abnormal condition, when the vehicle is unable to proceed along the road in its normal manner due to a major accident or the presence of a roadway obstruction, when the road is so slippery (e.g., due to ice or rain) that it is difficult to continue driving the vehicle or apply the brakes, or when the vehicle is driving on a road with fewer lanes because of roadwork or needs to bypass the roadwork.

For example, if the vehicle and/or the actual conditions fail to remain within the ODD, a minimal risk maneuver (hereinafter, “MRM”) may be performed. The term “MRM” may refer to a vehicle maneuvering procedure intended to minimize the risk of an accident, such as changing lanes or bringing the vehicle to a stop. The MRM may be needed in all situations where autonomous driving does not operate normally. The MRM is needed when there is an issue with one or more autonomous driving features. The MRM is needed when the vehicle and/or the actual conditions abruptly fall outside the ODD. The definition of a Minimal Risk Maneuver (MRM) and the circumstances under which an MRM may be required are not limited to the examples provided above.

While the foregoing is merely exemplary, the above descriptions provided regarding the ODD, the determination of whether the vehicle and/or the actual conditions remain within the ODD, and the MRM are not intended to be limiting.

One or more features associated with autonomous driving control may be activated based on configured autonomous driving control settings (e.g., based on at least one of an autonomous driving classification, a selection of an autonomous driving level for a vehicle, etc.). Based on one or more features (e.g., a feature of risk-adaptive ODD departure control) described herein, an operation of the vehicle may be controlled. For example, when the risk-adaptive ODD departure control detects a low-risk event (e.g., predictable toll gate or light rain), features such as lane keeping or adaptive cruise control may continue in standard mode. When an intermediary-risk event (e.g., potholes, degraded road markings, or moderate congestion) is detected, braking control, acceleration control, or alarm timing control may be adjusted to increase driver attentiveness. When a high-risk event (e.g., sudden sensor failure, severe weather, or imminent collision) is detected, braking time control, forward collision warning time control, or an autonomous driving deactivation may be triggered to execute a minimal risk maneuver. Thus, features associated with autonomous driving control may be dynamically adjusted according to the degree of risk associated with the ODD departure event.

One or more auxiliary devices (e.g., an engine brake, an exhaust brake, a hydraulic retarder, an electric retarder, or a regenerative brake) may also be controlled, for example, based on one or more features (e.g., a feature of risk-adaptive ODD departure control) described herein. For example, when a high-risk ODD departure event (e.g., sudden loss of traction or steep downhill slope during heavy rain) is detected, auxiliary devices may be activated to provide stronger braking support and stabilize the vehicle. When an intermediary-risk ODD departure event (e.g., degraded lane markings or moderate road curvature) is detected, auxiliary devices may be adjusted to limit acceleration and maintain safer deceleration margins. Conversely, when a low-risk ODD departure event (e.g., approaching a predictable toll gate or a gentle curve) is detected, auxiliary devices may remain in a standard mode while preparing for potential escalation. By controlling auxiliary devices in this risk-adaptive manner, the vehicle may maintain enhanced safety, stability, and energy efficiency according to the degree of risk associated with the ODD departure event.

One or more communication devices (e.g., a modem, a network adapter, a radio transceiver, or an antenna capable of communicating via one or more wired or wireless communication protocols, such as Ethernet, Wi-Fi, near-field communication (NFC), Bluetooth, Long-Term Evolution (LTE), 5G New Radio (NR), or vehicle-to-everything (V2X)) may also be controlled, for example, based on one or more features (e.g., a feature of risk-adaptive ODD departure control) described herein. For example, when a high-risk ODD departure event (e.g., sudden sensor blackout or severe collision risk) is detected, the communication device may prioritize transmitting emergency alerts or real-time vehicle status to external infrastructure or nearby vehicles via V2X. When an intermediary-risk ODD departure event (e.g., roadwork or degraded perception) is detected, the communication device may increase the frequency of status updates and maintain redundancy across multiple protocols (e.g., LTE and 5G NR). Conversely, when a low-risk ODD departure event (e.g., a predictable toll gate) is detected, the communication device may operate in a standard communication mode while still maintaining awareness of infrastructure signals. In this way, communication devices are adaptively controlled to ensure that external systems, nearby vehicles, and passengers remain informed and coordinated according to the degree of risk associated with the ODD departure event.

Minimum risk maneuver (MRM) operation(s) may also be controlled, for example, based on one or more features (e.g., a feature of risk-adaptive ODD departure control) described herein. A minimal risk maneuvering operation (e.g., a straight stop, in-lane stop, half-shoulder stop, or full-shoulder stop) may be adaptively selected according to the degree of risk associated with an ODD departure event. For example, when a high-risk ODD departure event (e.g., sudden sensor failure, severe weather, or unexpected obstacle) is detected, the processor may control the vehicle to perform a more urgent maneuver such as a full-shoulder stop to maximize safety. When an intermediary-risk ODD departure event (e.g., degraded perception performance or moderate roadwork zone) is detected, the processor may instead perform an in-lane stop or half-shoulder stop. Conversely, when a low-risk ODD departure event (e.g., predictable toll gate or mild rain) is detected, the processor may initiate a controlled straight stop while maintaining stability. During such MRMs, one or more processors of the vehicle may dynamically adjust the maneuver based on additional factors such as remaining time to the ODD departure location, the presence of nearby safety zones, traffic density, or road conditions. In this way, MRM operations are adaptively controlled to minimize collision risks and bring the vehicle to a lowered risk state under varying ODD departure scenarios.

Biased driving operation(s) may also be controlled, for example, based on one or more features (e.g., a feature of risk-adaptive ODD departure control) described herein. A driving control apparatus may perform a biased driving control that adaptively adjusts the vehicle’s lateral position in a lane according to the degree of risk associated with an ODD departure event. For example, when a high-risk ODD departure event (e.g., roadwork zone, narrow lane with barriers, or adjacent heavy vehicles) is detected, the driving control apparatus may bias the lateral distance toward the safer side of the lane to reduce collision risk. Conversely, when a low-risk ODD departure event (e.g., approaching a predictable toll gate or well-marked highway exit) is detected, the apparatus may maintain the vehicle more centrally within the lane to maximize stability and comfort. The biased target lateral distance may therefore be dynamically determined based on factors such as the degree of risk associated with the ODD departure event, the vehicle’s speed, road surface conditions (e.g., wet, icy, or uneven), surrounding traffic density, or the presence of obstacles. By controlling the biased driving operation in this risk-adaptive manner, the system may improve the vehicle’s stability, safety, and performance under varying ODD departure scenarios.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., a feature of risk-adaptive ODD departure control) described herein. In this context, the activation frequency, sensitivity level, or data fusion of the sensors may be adaptively adjusted according to a risk degree of an ODD departure event. For example, when a high-risk ODD departure event (e.g., heavy rain, roadwork zone, or sudden obstacle) is detected, the processor may increase the sampling rate of the camera or LIDAR, enhance object recognition thresholds of the RADAR, or activate additional sensors such as ultrasonic sensors for redundancy. Conversely, during low-risk ODD departure events (e.g., approaching a predictable toll gate or highway exit), the system may operate sensors in a lower-power or reduced-sensitivity mode to optimize efficiency while maintaining safe monitoring.

An autonomous driving level and/or autonomous driving activation/deactivation may also be controlled, for example, based on one or more features (e.g., a feature of risk-adaptive ODD departure control) described herein. A driving control apparatus may perform an autonomous driving level control (e.g., a change of an autonomous driving level, a change of a required user attentiveness, etc.) or cause deactivation of an autonomous driving operation based on a risk degree associated with an ODD departure event. For example, by adjusting the required user attentiveness in response to the determined risk degree, the driver may be required to place his/her hands on the steering wheel more frequently (e.g., at least once in a threshold time period, such as five seconds, 30 seconds, 1 minute, etc.). By changing the required user attentiveness, the driver may also be required to look ahead more often (e.g., at least once in a threshold time period, such as five seconds, 30 seconds, 1 minute, etc.). Further, by changing the autonomous driving level or initiating deactivation in response to a high-risk ODD departure event, one or more video contents may not be displayed on a display of the vehicle, thereby encouraging the driver to focus on the driving environment.

According to the present disclosure, an autonomous driving apparatus is provided that determines whether a vehicle remains within its operational design domain (ODD) and responds appropriately when departure from the ODD is likely. The apparatus may classify ODD departure events based on their location and predictability, such as toll gates at fixed and predictable locations, potholes at fixed but unpredictable locations, weather events like heavy rain at unfixed and unpredictable locations, and roadwork at unfixed but predictable locations. The apparatus may further assess the degree of risk associated with such events. Based on the type and risk degree of an ODD departure event, the apparatus may variably control the vehicle, for example by requesting driver takeover, limiting vehicle driving performance, or executing a minimal risk maneuver such as an in-lane stop, a straight stop, a half-shoulder stop, or a full-shoulder stop. In this manner, the apparatus enables the vehicle to maintain safe autonomous driving operation under diverse conditions and to minimize risks when conditions fall outside the ODD.

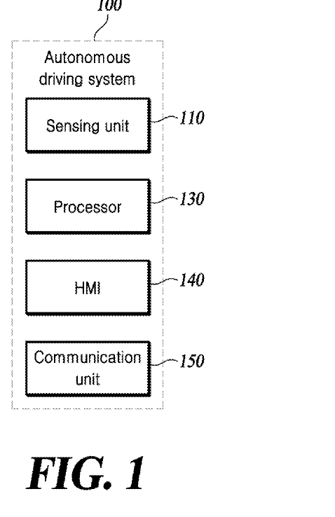

FIG. 1 shows an example of an autonomous driving system according to an example of the present disclosure.

Referring to FIG. 1, an autonomous driving system 100 may include a sensor unit 110, a processor 130, an HMI (human-machine interface) 140, a communication unit 150, and a memory (not shown). The components of the autonomous driving system 100 according to the present disclosure are not limited to those illustrated in FIG. 1, and may further include other components (e.g., a power management circuit, a navigation module, or a dedicated safety controller, etc.) not explicitly shown in FIG. 1.

The autonomous driving system 100 according to the present disclosure may control the vehicle to drive autonomously.

The autonomous driving system 100 according to the present disclosure may gather information on the vehicle and the vehicle’s surrounding environment in real time by using the sensor unit 110. The autonomous driving system 100 may obtain information on the vehicle and/or the actual conditions by using the sensor unit 110 (e.g., weather, road surface, or nearby traffic density, etc.).

The autonomous driving system 100 may identify an ODD departure event of the vehicle based on status information on the vehicle and the surrounding environment.

The autonomous driving system 100 may determine the type of an ODD departure event, based on at least one of the location and predictability of the ODD departure event.

The autonomous driving system 100 may control the vehicle in different ways depending on the type of the ODD departure event.

The autonomous driving system 100 may determine the degree of risk degree associated with an ODD departure event by using various methods. Several examples of such various methods are provided below.

The autonomous driving system 100 may determine the degree of risk associated with the ODD departure event based on the type of the ODD departure event. The autonomous driving system 100 may determine the degree of risk differently depending on whether or not the ODD departure event is predictable (e.g., toll gates, highway exits, or scheduled roadwork are predictable, while sudden rain or unexpected obstacles are not predictable, etc.).

Alternatively, the autonomous driving system 100 may determine the degree of risk associated with the ODD departure event based on the location of the ODD departure event. The autonomous driving system 100 may determine the degree of risk associated with the ODD departure event differently depending on whether or not the ODD departure event is predictable.

Alternatively, the autonomous driving system 100 may determine the degree of risk associated with the ODD departure event based solely on where or not the ODD departure is predictable, without considering the type of the ODD departure event.

Alternatively, the autonomous driving system 100 may determine the degree of risk associated with the ODD departure event based solely on whether the ODD departure event is predictable, without considering the location of the ODD departure event.

The method by which the autonomous driving system 100 determines the degree of risk is not limited by the above examples.

The sensor unit 110 includes at least one sensor. The sensor unit 110 may generate data on each of the components of the vehicle by using at least one sensor (e.g., wheel speed sensor, yaw rate sensor, throttle position sensor, or steering torque sensor, etc.). Data on each component of the vehicle obtained by the sensor unit 110 and data generated internally by these components of the vehicle may be aggregated and collectively defined as vehicle data.

The vehicle data may include data on vehicle speed, acceleration speed, steering angle, brake pad temperature, brake pad wear level, engine RPM, remaining fuel level, coolant temperature, tire pneumatic pressure, engine oil condition, battery voltage, temperatures inside/outside a vehicle compartment, current vehicle location, transmission temperature, or other operational data (e.g., door status, seat belt status, wiper operation, or light status, etc.). The vehicle data according to the present disclosure is not limited by the above examples. The processor 130 may determine the status of the vehicle based on the obtained vehicle data. That is, the processor 130 may determine whether each of the components of the vehicle is functioning properly and detect a mechanical/electronic fault in them.

The sensor unit 110 may generate sensing data (hereinafter, “surroundings sensing data”) for the surrounding environment of the vehicle by sensing the surrounding environment of the vehicle by using at least one sensor.

The processor 130 may determine the surrounding environment of the vehicle and the circumstances surrounding the vehicle based on the obtained surroundings sensing data. For example, the processor 130 may analyze the surroundings sensing data and determine weather conditions (heavy rain, heavy snow, thick fog, backlighting, temperature, or strong wind, etc.), road conditions (sinkholes, cracks in the road, black ice, rain-slicked roads, fallen debris, or gravel, etc.), transportation accidents, and traffic congestion.

The processor 130 may acquire information regarding objects around the vehicle - for example, other vehicles, people, physical objects, curbs, guardrails, lanes, lines, obstacles, traffic signs, traffic lights, or construction barriers, etc. The information regarding objects around the vehicle may include at least one of object location, object size, object shape, distance to object, and speed relative to object.

The surroundings sensing data according to the present disclosure is not limited by the examples provided above.

The processor 130 may determine in real time whether the vehicle’s status and/or the actual conditions remain within the ODD based on the vehicle data and/or the surroundings sensing data.

The sensing unit 110 may include a camera, LIDAR (light detection and ranging), RADAR (radio detection and ranging), an ultrasonic sensor, an infrared sensor, and a location measurement sensor (e.g., GPS, GNSS, or DGPS, etc.). The sensors listed above are provided solely for illustrative purposes to aid understanding, and the sensors of the present disclosure are not limited to these sensors.

At least one camera may capture the inside of the vehicle. The camera may generate user capture data by capturing a user inside the vehicle. The type of the camera is not limited. For example, the camera may be an optical camera, a thermal camera, an infrared camera, or a depth-sensing camera, or a stereo camera, etc.

The processor 130 may determine whether the user is in a situation in which they are capable of driving, based on the user capture data. The processor 130 may enable an autonomous driving mode based on the user capture data. The processor 130 may perform a control operation for transitioning between different autonomous driving modes or continuing the current autonomous driving mode based on the user capture data (e.g., switching from manual mode to Level 2 assistance, or from Level 2 to Level 3 autonomous mode, etc.).

The camera may generate data on objects located at the front, rear, and side of the vehicle by capturing the surroundings of the vehicle (e.g., parked vehicles, cyclists, pedestrians, traffic cones, or animals, etc.).

The LiDAR may generate data on objects located at the front, rear, and side of the vehicle by using light (or laser).

The radar may generate data on objects located at the front, rear, and side of the vehicle by using electromagnetic waves (or radio waves) (e.g., detecting moving vehicles, stationary barriers, or approaching motorcycles, etc.).

The ultrasonic sensor may generate data on objects located at the front, rear, and side of the vehicle by using ultrasonic waves (e.g., nearby vehicles during parking, curbs, garage walls, or pedestrians in close proximity, etc.). The infrared sensor may generate data on objects located at the front, rear, and side of the vehicle by using infrared rays (e.g., warm-bodied animals, pedestrians at night, or heated road surfaces, etc.).

The sensor unit 110 may measure the current location of the vehicle by using a location measurement sensor. The sensor unit 110 may include a GPS (Global Positioning System) sensor, a DGPS (Differential Global Positioning System) sensor, and a GNSS (Global Navigation Satellite System) sensor (e.g., Galileo, GLONASS, or BeiDou, etc.). Vehicle location data may be generated based on signals generated by location measurement sensors such as the GPS sensor, the DGPS sensor, and the GNSS sensor (e.g., longitude/latitude coordinates, altitude, or heading direction, etc.).

The autonomous system 100 may acquire weather information for the surroundings of the vehicle by using the sensor unit 110. For example, the processor 130 may determine whether it is raining, based on a signal from a rain sensor (or determine snow, fog, humidity, or bright sunlight conditions, etc.).

The processor 130 may control each component of the vehicle. The processor 130 may control the sensor unit 110, the HMI 140, and the communication unit 150. The processor 130 may control each component of the vehicle so as to perform steering, acceleration, deceleration, braking, lane change, line detect, lateral control, object (or obstacle) detection and distance sensing, powertrain control, and safe area sensing (e.g., emergency evasive steering, adaptive cruise adjustments, or regenerative braking control, etc.).

The processor 130 may control autonomous driving of the vehicle. The processor 130 may determine whether any abnormalities exist in the features necessary for autonomous driving. The features necessary for autonomous driving may include, for example, line detect, lane change, lateral control, deceleration (or brake control), powertrain control, safe area sensing, and object (obstacle) detection and distance sensing (e.g., loss of lane markings, abnormal engine torque, or sensor blind spots, etc.).

The processor 130 may determine whether any abnormalities exist in each of the components of the vehicle, based on signals received from each component or signals received from the sensor unit 110. That is, the processor 130 may determine whether any abnormalities exist in each of the components of the vehicle, based on vehicle data and/or surroundings sensing data (e.g., abnormal tire pressure readings, faulty brake signals, or degraded camera images, etc.).

The processor 130 may enable an autonomous driving mode. The processor 130 may perform a control operation for transitioning between different autonomous driving modes or continuing the current autonomous driving mode. For example, the processor 130 may transition from an Adaptive Cruise Control (ACC) mode to a Lane Keeping Assist (LKA) mode. The processor 130 may perform a control operation for transitioning between different autonomous driving levels. For example, the processor 130 may transition from Autonomous Driving Level 1 mode to Autonomous Driving Level 2 mode (or from Level 2 to Level 3 conditional automation, etc.).

The HMI 140 may include a display, a speaker, a haptic device (e.g., a handle, a steering wheel, a seat, buttons, a vibrating seat, or a touchscreen, etc.), and an input means. In the present disclosure, the HMI 140 refers to an interface configured to allow a passenger and the vehicle to interact with each other.

The HMI 140 may deliver various information to the passenger by using visual, auditory, and tactile signals. For example, the HMI 140 may provide guidance on vehicle speed, initiation/termination of autonomous driving, handover of control authority, transition between autonomous driving modes, real-time driving path, nearby traffic situations, warning sound output, weather information, and initiation/completion of lane change (e.g., display of blind-spot alerts, haptic lane-departure warnings, or spoken navigation guidance, etc.). The components of the HMI 140 according to the present disclosure and the functions of the HMI 140 are not limited by the examples provided above.

The passenger may enter a command for controlling the vehicle by using the HMI 140. For example, the passenger may enter a command for controlling the vehicle by using the buttons, touchscreen, and voice recognition functionality of the HMI 140 (e.g., issuing a spoken request to change destination, tapping to adjust cruising speed, or pressing a button to activate parking assist, etc.).

The input means of the HMI 140 may include buttons, a touchscreen, and a microphone for voice recognition functionality (and may further include gesture sensors or rotary controllers, etc.). The user may configure an autonomous driving mode by using the input means of the HMI 140 (e.g., enabling eco-driving, choosing highway-assist mode, or activating parking mode, etc.).

The HMI 140 may inform the user of the activation of, continuation of, or transition between autonomous driving modes, by using visual, auditory, and tactile signals (e.g., dashboard icons, spoken announcements, or haptic vibrations, etc.). The HMI 140 may inform the user that the autonomous driving modes has been automatically or manually transitioned.

If there is a mode transition from Autonomous Driving Level 2 to Autonomous Driving Level 3, the HMI 140 may provide the user with information on a road section where the vehicle can travel at Autonomous Driving Level 3. For example, the HMI 140 may issue a message saying “The vehicle will operate at Autonomous Driving Level 3 for up to 3 km from the current location” via a visual and/or auditory signal (e.g., dashboard text display, head-up display alert, or synthesized voice output, etc.).

If the user requests for a manual mode transition but the mode transition is not available, the HMI 140 may inform the user of the unavailability of the mode transition (e.g., “Level 3 not available on this road segment,” etc.). If the mode has been automatically transitioned without the user’s request, the HMI 140 may inform the user of the mode transition. If the user does not perform DDT immediately even when an increase in DDT demand is anticipated or has already occurred, the HMI 140 may issue a warning sound (e.g., repetitive beeps, a spoken command, or a seat vibration, etc.) to alert the user.

The display may show the entire path leading to a final destination. The display may show a portion of the entire path where autonomous driving will be performed (e.g., highway segments, urban road portions, or intersections, etc.). The display may show the level and/or mode of autonomous driving that is currently active (e.g., ACC, LKA, or Level 3 highway pilot, etc.).

The communication unit 150 may support V2X(Vehicle-to-Everything) communication and communicate with external equipment under the control of the processor 130. The communication unit 150 may perform communication by using a wireless communication protocol or a wired communication protocol (e.g., 5G, LTE, DSRC, Wi-Fi, Ethernet, or CAN, etc.).

The memory stores map data. The map data may be data on a road or a high-definition map of a road. For example, the map data may be data on road gradient, road width, road length, road curvature, and the rate of curvature change along the road (e.g., lane markings, traffic sign positions, or construction zones, etc.). The processor 130 may determine whether the ODD for a specific road is met, based on the stored map data.

The vehicle may perform autonomous driving in various modes under the control of the autonomous driving system 100. The autonomous driving system 100 may autonomously or manually transition the autonomous driving mode (e.g., switching to parking assist, adaptive cruise, or highway pilot, etc.).

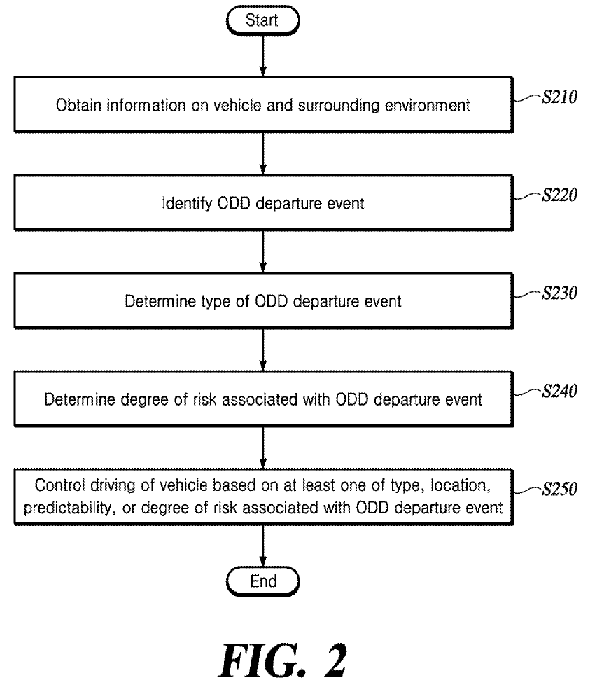

FIG. 2 shows an example of a control method for an autonomous driving system according to an example of the present disclosure.

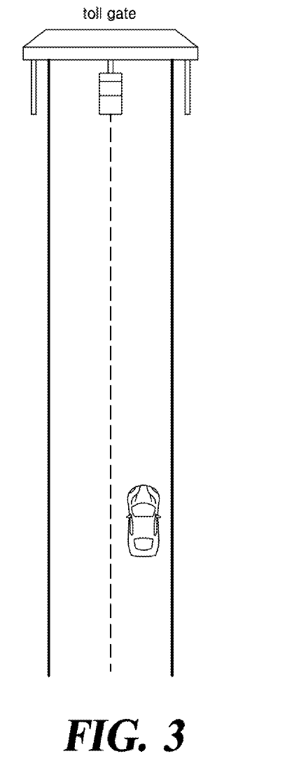

FIG. 3 shows an example of a toll gate on the road where the vehicle is driving according to an example of the present disclosure.

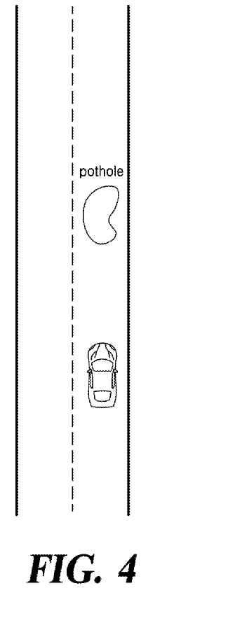

FIG. 4 shows an example of a pothole on the road where the vehicle is driving according to an example of the present disclosure.

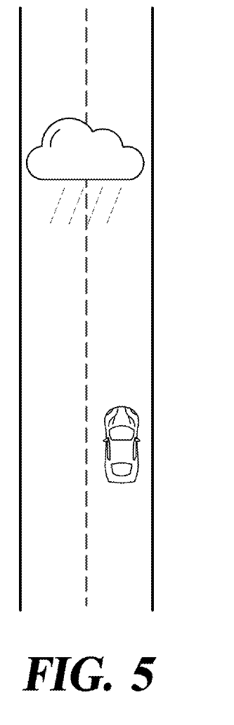

FIG. 5 shows an example of a road scene where the vehicle is driving in the rain according to an example of the present disclosure.

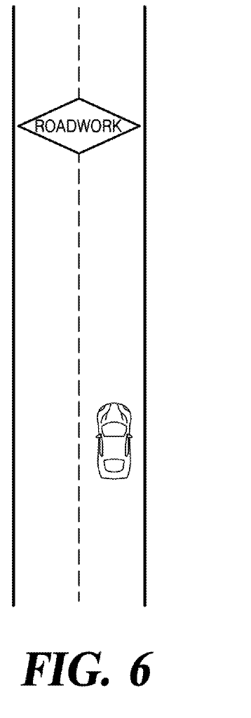

FIG. 6 shows an example of a roadwork site on the road where the vehicle is driving according to an example of the present disclosure.

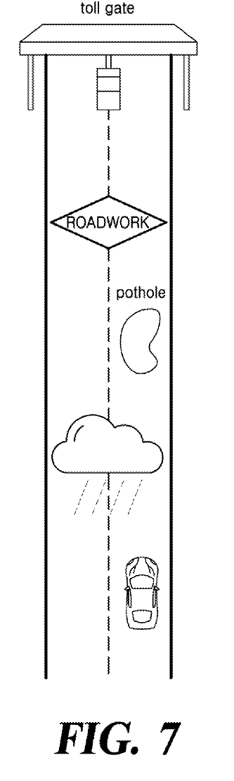

FIG. 7 shows an example of a toll gate, a pothole, and a roadwork site on the road where the vehicle is driving in the rain according to an example of the present disclosure.

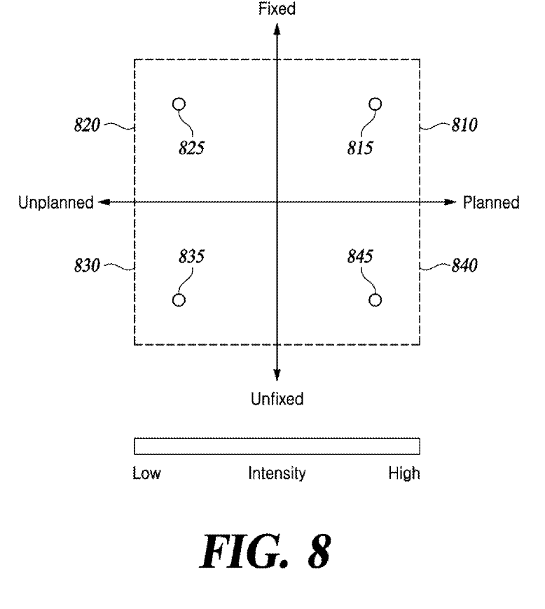

FIG. 8 shows an example of types of ODD departure events according to an example of the present disclosure.

Referring to FIG. 2 through FIG. 8, the control method for the autonomous driving system 100 will be described. For example, descriptions will be given with respect to a method of identifying an OOD departure event among a number of events detected by the autonomous driving system 100, a method of determining the type of the identified ODD departure event, a method of determining the degree of risk associated with the ODD departure event, and a method of controlling the vehicle based on the degree of risk. S210 in FIG. 2 will be described. The autonomous driving system 100 may obtain information on the vehicle and the surrounding environment (S210). Specifically, the autonomous driving system 100 may obtain information on the vehicle and the surrounding environment based on signals received from the sensor unit 110 and signals received from each component (e.g., steering system, braking system, or engine control unit, etc.).

S220 in FIG. 2 will be described. The autonomous driving system 100 may identify an ODD departure event (S220). The processor 130 may detect various events for the vehicle based on the obtained information on the vehicle and the surrounding environment, and then may identify an ODD departure event among the detected events (e.g., obstacles, adverse weather, or road surface anomalies, etc.).

As used herein, the term “ODD departure event” refers to an event that triggers a vehicle capable of autonomous driving to depart from the ODD, among various events the vehicle encounter. Also, the ODD departure event encompasses events that occurred in the past, current events, and events expected to occur in the future (e.g., an already-passed toll gate, an ongoing heavy snowstorm, or upcoming construction zone, etc.).

The ODD departure event will be further described with reference to FIGS. 3 through 7. An example will be described in which a toll gate is located ahead of a vehicle that is autonomously driving on a highway, as shown in FIG. 3. The likelihood of the vehicle departing from the ODD at the toll gate may vary depending on the autonomous driving level or mode (e.g., Level 2 requiring takeover vs. Level 4 handling toll gates automatically, etc.). If an ODD departure is triggered by the toll gate, the toll gate may correspond to an ODD departure event. Also, the toll gate corresponds to an ODD departure event that is expected to occur in the near future. Once the vehicle has passed the toll gate, the ODD departure event corresponding to the toll gate is terminated.

An example will be described in which a pothole is present on the road where the vehicle is traveling, as shown in FIG. 4. If the vehicle’s departure from the ODD is triggered by the pothole, the pothole may correspond to an ODD departure event. It should be noted that the likelihood of the vehicle departing from the ODD may vary depending on the location or size of the pothole (e.g., shallow cracks, wide sinkholes, or longitudinal grooves, etc.). An example will be described in which the vehicle is driving on the road in the rain, as shown in FIG. 5. If the vehicle’s departure from the ODD is triggered by the rain, the rain may correspond to an ODD departure event. A drizzle event, for example, may not correspond to an ODD departure event, since the vehicle can continue autonomous driving under such a condition. If intense rain hinders the vehicle’s sensors from recognizing objects or renders autonomous driving infeasible, the intense rain event may correspond to an ODD departure event (similar logic may apply to heavy snow, hailstorms, or dense fog, etc.).

An example will be described in which a roadwork site is present on the road where the vehicle is driving, as shown in FIG. 6. If the vehicle’s departure from the ODD is triggered by the roadwork site, the roadwork site may correspond to an ODD departure event. It should be noted that the likelihood of the vehicle departing from the ODD may vary depending on the location or extent of the roadwork site (e.g., partial lane closure, full road closure, or moving construction vehicles, etc.).

In the scenario illustrated FIG. 7 where the vehicle is driving in the rain on a road that includes a toll gate, a pothole, and a roadwork site, the processor 130 may determine whether the toll gate, pothole, rain, and roadwork site events each correspond to an ODD departure event (S220).

S230 in FIG. 2 will be described. The autonomous driving system 100 may determine the type of the ODD departure event (S230). The processor 130 may determine the type of the ODD departure event, based on at least one of the location and predictability of the ODD departure event (e.g., fixed and predictable toll gates, fixed but unpredictable potholes, unfixed and unpredictable weather, or unfixed and predictable construction, etc.). The type of the ODD departure event will be described. According to an example, the processor 130 may classify the type of the ODD departure event as a first type 815 through a fourth type 845.

If the ODD departure event occurs at a fixed location and the ODD departure event is predictable, the processor 130 classifies the ODD departure event as the first type 815. In this case, if the ODD departure event is predictable, this may mean that the ODD departure event is a planned event. For example, the toll gate may correspond to a planned ODD departure event (e.g., highway toll booths, expressway ticketing gates, or customs checkpoints, etc.). On the other hand, if the ODD departure event is not predictable, this may mean that the ODD departure event is an unplanned event. For example, a rain shower may correspond to an unplanned ODD departure event (e.g., sudden hail, unexpected snow flurries, or flash flooding, etc.).

An ODD departure event corresponding to the first type 815 may be shown in a first area 810 in FIG. 8. For example, a toll gate and a highway exit are at fixed locations and predictable, and accordingly the processor 130 may classify the toll gate and the highway exit as an ODD departure event corresponding to the first type 815 (e.g., bridge tolls, tunnel entrances, or controlled-access ramps, etc.).

If the ODD departure event occurs at a fixed location and the ODD departure event is not predictable, the processor 130 classifies the ODD departure event as the second type 825. An ODD departure event corresponding to the second type 825 may be shown in a second area 820 in FIG. 8. For example, pedestrians on a crosswalk and a pothole are at fixed locations and not predictable, and accordingly the processor 130 may classify the pedestrians on a crosswalk and the pothole as an ODD departure event corresponding to the second type 825 (e.g., fallen cargo on the road, traffic accidents blocking a lane, or sudden sinkholes, etc.).

If the ODD departure event occurs at an unfixed location and the ODD departure event is not predictable, the processor 130 classifies the ODD departure event as the third type 835. An ODD departure event corresponding to the third type 835 may be shown in a third area 830 in FIG. 8. For example, since it is not possible to determine where and when it will rain, rain is considered to occur at an unfixed location and is not predictable. Accordingly, the processor 130 may classify rain as an ODD departure event corresponding to the third type 835 (e.g., heavy fog, drifting snow, sandstorms, or sudden dust clouds, etc.).

If the ODD departure event occurs at an unfixed location and the ODD departure event is predictable, the processor 130 classifies the ODD departure event as the fourth type 845 (e.g., mobile roadwork sites, traffic detours, parades occupying public roads, or utility maintenance zones, etc.). An ODD departure event corresponding to the fourth type 845 may be shown in a fourth area 840 in FIG. 8. For example, a roadwork site is considered to be at an unfixed location because it may be relocated as the work progresses, and is also considered to be predictable because the roadwork proceeds as planned. Since the roadwork site occurs at an unfixed location and predictable, the processor 130 may classify the roadwork site as an ODD departure event corresponding to the fourth type 845 (e.g., scheduled parades, temporary traffic diversions, or planned utility maintenance sites, etc.).

S240 and S250 in FIG. 2 will be described. The autonomous driving system 100 may determine the risk degree of the ODD departure event (S240). Also, the autonomous driving system 100 may determine the risk degree of the ODD departure event, based on the intensity of the ODD departure event (e.g., light rain vs. torrential downpour, minor pothole vs. deep sinkhole, or partial lane closure vs. full roadblock, etc.).

The autonomous driving system 100 may control the vehicle based on at least one of the type, location, predictability, and degree of risk associated with the ODD departure event (S250). Also, the autonomous driving system 100 may control the vehicle, based on the intensity of the ODD departure event.

The processor 130 may determine the degree of risk associated with the ODD departure event to be higher as the likelihood of the vehicle departing from the ODD of the ODD departure event increases.

The degree of risk may include low risk, intermediary risk, and high risk (e.g., low risk for drizzle, intermediary risk for moderate rain, high risk for intense rain that blinds sensors, etc.).

If the ODD departure event corresponds to the first type 815 and the vehicle has not yet reached the location of the ODD departure event, the processor 130 then may determine the degree of risk as low. If the ODD departure event corresponds to the first type 815 and has a low risk, the processor 130 may perform a control operation for requesting the passenger to perform DDT. As used herein, the control operation for requesting to perform DDT may be making a request to hand over the authority over vehicle control from the autonomous driving system 100 to the passenger (e.g., issuing a dashboard alert, a voice command, or a steering wheel vibration, etc.).

If the ODD departure event corresponds to the first type 815 and the vehicle has reached the location of the ODD departure event, the processor 130 then may determine the degree of risk as high. If the ODD departure event corresponds to the first type 815 and has a high risk, the processor 130 may perform shoulder stop control using an MRM, as will be described later (e.g., controlled deceleration to the shoulder, hazard light activation, or broadcasting a V2X warning to nearby vehicles, etc.).

If the ODD departure event corresponds to the second type 825, the processor 130 may determine the degree of risk based on at least one of perception failure rate, control error rate, and duration. As used herein, the term “perception failure rate” may refer to the rate at which the autonomous driving system 100 incorrectly perceives or fails to recognize the surrounding environment. That is, the perception failure rate may indicate the rate of errors that occur when the autonomous driving system 100 incorrectly interprets objects or situations in the surroundings or fails to recognize them at all (e.g., misclassifying a pedestrian as a sign, failing to detect a stopped vehicle, or missing a lane marking, etc.). For example, the processor 130 may determine the degree of risk to be higher as the perception failure rate of the autonomous driving system 100 increases due to a harsh external environment (e.g., glare, fog, or heavy snow, etc.). In this context, the term “control error rate” may refer to the rate of errors between the vehicle’s target driving status (speed, position, direction, etc.) and the actual driving status. That is, the control error rate may serve as an index for evaluating whether the vehicle is moving correctly as intended. For example, the processor 130 may determine the degree of risk to be higher as the rate of errors in the longitudinal and lateral control of the vehicle increases (e.g., excessive deviation from lane center, unstable speed control, or unintended steering drift, etc.). As used herein, the term “duration” refers to the length of time that the ODD departure event lasts (e.g., rain lasting for several minutes, prolonged construction delays, or recurring sensor-blocking glare, etc.).

If the ODD departure event corresponds to the second type 825, the processor 130 may determine the degree of risk as low when the perception failure rate, control error rate, and duration thereof are within respective threshold limits (e.g., stable sensor performance, minimal deviation in steering, or brief pothole exposure, etc.). If an ODD departure event corresponds to the second type 825, the processor 130 may determine the degree of risk as intermediary when one of the perception failure rate, control error rate, and duration thereof exceeds the threshold limit (e.g., delayed pedestrian recognition, excessive steering oscillation, or prolonged time navigating a fixed obstacle, etc.). If the ODD departure event corresponds to the second type 825 and has a low risk or an intermediary risk, the processor 130 may perform at least one of a control operation for requesting the passenger to perform DDT and a control operation for limiting the driving performance of the vehicle. The control operation for limiting the driving performance of the vehicle may refer to a control operation for limiting the maximum speed of the vehicle, the maximum RPM of the vehicle, low-level autonomous driving functions, and so on (e.g., capping acceleration, restricting lane-change permissions, or disabling overtaking assist, etc.). The low-level autonomous driving functions that can be limited by the processor 130 may include, for example, adaptive cruise control, automated lane change, and automated lane keeping function (e.g., lane centering, parking assist, or stop-and-go traffic assist, etc.), and so on.

If the ODD departure event corresponds to the second type 825, the processor 130 may determine the degree of risk as high when at least two of the perception failure rate, control error rate, and duration thereof exceed the threshold limits (e.g., simultaneous pedestrian misdetection and high steering error during a prolonged crosswalk blockage, etc.). If the ODD departure event corresponds to the second type 825 and has a high risk, the processor 130 may perform either in-lane stop control or straight stop control using an MRM, as will be described later (e.g., gradual braking to a stop in the current lane, or controlled deceleration along a straight trajectory, etc.).

If the ODD departure event corresponds to the third type 835, the processor 130 may determine the degree of risk based on at least one of the perception failure rate, control error rate, duration, and frequency thereof. As used herein, “frequency" refers to how often an ODD departure event occurs (e.g., repeated lane departures, recurring fog episodes, or frequent icy patches, etc.). The processor 130 may classify an event involving the vehicle’s departure from the current lane as an ODD departure event (e.g., drifting across lane markings, weaving within a lane, or failing to maintain lane center, etc.). The processor 130 may determine the frequency to be higher as the departure from the current lane occurs more frequently. The processor 130 may determine the frequency of rain to be higher if it rains more frequently (e.g., seasonal monsoon rains, recurring daily showers, or extended storm systems, etc.).

If the ODD departure event corresponds to the third type 835, the processor 130 may determine the degree of risk as low when the perception failure rate, control error rate, duration, and frequency thereof are within respective threshold limits (e.g., sensors detect correctly, vehicle control remains stable, rain is short-lived, and weather disruptions are rare, etc.). If the ODD departure event corresponds to the third type 835, the processor 130 may determine the degree of risk as intermediary when at least one of the perception failure rate, control error rate, duration, or frequency thereof exceeds the threshold limit (e.g., occasional sensor misclassification, single extended lane departure, or one-off prolonged rainstorm, etc.). If the ODD departure event corresponds to the third type 835 and has a low risk or an intermediary risk, the processor 130 may perform at least one of a control operation for requesting the passenger to perform DDT and a control operation for limiting the driving performance of the vehicle (e.g., reducing maximum speed, disabling lane-change assist, or requesting driver takeover with a visual alert, etc.).

If the ODD departure event corresponds to the third type 835, the processor 130 may determine the degree of risk as high when at least two of the perception failure rate, control error rate, duration, and frequency thereof exceed the threshold limits (e.g., frequent lane departures combined with poor steering stability and prolonged adverse weather, etc.). If the ODD departure event corresponds to the third type 835 and has a high risk, the processor 130 may perform either in-lane stop control or straight stop control using an MRM (e.g., controlled braking to a full stop in-lane with hazard lights, or a straight deceleration maneuver until the vehicle halts safely, etc.).

If the ODD departure event corresponds to the fourth type 845 and the vehicle has not yet reached the location of the ODD departure event, the processor 130 then may determine the degree of risk as low (e.g., approaching but not yet entering a planned roadwork zone, or approaching a parade site that begins farther ahead, etc.). If the ODD departure event corresponds to the fourth type 845 and has a low risk, the processor 130 may perform a control operation for requesting the passenger to perform DDT (e.g., providing a dashboard alert, issuing a spoken request, or vibrating the steering wheel, etc.).

If the ODD departure event corresponds to the fourth type 845 and the vehicle has reached the location of the ODD departure event, the processor 130 then may determine the degree of risk as high (e.g., entering an active construction site with lane closure, or reaching the start of a scheduled roadblock, etc.). If the ODD departure event corresponds to the fourth type 845 and has a high risk, the processor 130 may perform either shoulder stop control or in-lane stop control using an MRM (e.g., pulling onto a road shoulder where available, or bringing the vehicle to a controlled stop in the lane when no shoulder exists, etc.).

In order to perform the steps S210 through S250 described above, the autonomous driving system 100 may utilize such components as the sensor unit 110, the processor 130, the HMI 140, and the communication unit 150. In addition, the control method performed by the autonomous driving system 100 is not limited by the foregoing descriptions and examples. The processor 130 may determine the risk degree of an ODD departure event in various ways. The processor 130 may control the vehicle in various ways based on the risk degree of an ODD departure event. Examples of a variety of methods for determining the risk degree of an ODD departure event and various methods for controlling the vehicle will be described below.

According to an example, the processor 130 may determine the risk degree of an ODD departure event by considering at least one of the type, location, and predictability of the ODD departure event (e.g., toll gate events, moving construction sites, or sudden weather changes, etc.).

According to an example, the processor 130 may determine the degree of risk associated with an ODD departure event, based on the type of the ODD departure event and/or whether or not the ODD departure event is predictable (e.g., planned toll booths vs. unplanned potholes, etc.).

According to an example, the processor 130 may determine the degree of risk associated with an ODD departure event, based on whether or not the ODD departure event is predictable. For example, the risk degree of an ODD departure may be considered to be lower when the ODD departure is predictable than when it is not (e.g., a scheduled toll gate vs. a sudden sinkhole, etc.).

If the ODD departure event is predictable, the processor 130 may determine the degree of risk based on at least one of the remaining distance for the vehicle to reach the location of the ODD departure event, the remaining time for the vehicle to reach that location, and the presence or absence of a safety zone near that location (e.g., emergency stop lanes, highway shoulders, or nearby rest areas, etc.). In this context, the safety zone may refer to a physical space that can minimize the risk degree that the vehicle might face during the ODD departure event (e.g., a pull-off area in a tunnel, a widened shoulder on a bridge, or an emergency lane on a highway, etc.).

If the ODD departure event is not predictable, the processor 130 may determine the degree of risk based on at least one of the intensity, duration, and frequency of the ODD departure event. In this context, the intensity of an ODD departure event refers to a magnitude or intensity with which the departure event occurs (e.g., light drizzle, moderate rainfall, or torrential downpour, etc.). The intensity of drizzle is relatively low, and the intensity of heavy rain is relatively high (e.g., mild fog vs. dense fog, or scattered snow flurries vs. a blizzard, etc.).

According to an example, the processor 130 may determine the degree of risk associated with the ODD departure event, based on the type of the ODD departure event (e.g., fixed predictable events like toll booths, fixed unpredictable events like potholes, unfixed unpredictable events like sudden rain, or unfixed predictable events like roadwork, etc.).

According to an example, the processor 130 may perform at least one of a control operation for limiting the driving performance of the vehicle, a control operation for requesting the passenger to perform DDT, and an MRM control operation, based on the degree of risk (e.g., reducing maximum speed, issuing a takeover alert, or initiating a shoulder stop, etc.).

According to an example, if the degree of risk is low and the remaining time for the vehicle to reach the ODD departure event is equal to or greater than a time threshold, the processor 130 may perform the control operation for limiting the driving performance of the vehicle (e.g., limiting acceleration, capping RPM, or disabling lane-change assist, etc.).

According to an example, if the degree of risk is low and the remaining distance for the vehicle to reach the ODD departure event is equal to or greater than a distance threshold, the processor 130 may perform the control operation for limiting the driving performance of the vehicle. The time threshold and/or distance threshold may be configured by the manufacturer of the autonomous driving system 100, the processor 130, or the passenger (e.g., a manufacturer-defined default, an adaptive system-calculated threshold, or a user-adjusted preference, etc.).

According to an example, if the degree of risk is high, if the remaining time for the vehicle to reach the ODD departure event is less than a time threshold, or if the remaining distance for the vehicle to reach the ODD departure event is less than a distance threshold, the processor 130 may perform at least one of the control operation for requesting the passenger to perform DDT and the MRM control operation (e.g., issuing urgent takeover alerts, executing in-lane stop control, or performing a full-shoulder stop, etc.).

According to an example, when the ODD departure event ends, the autonomous driving system 100 may discontinue the control operation for limiting the driving performance of the vehicle which was triggered by the ODD departure event, and perform a control operation for restoring the driving performance of the vehicle to normal (e.g., re-enabling adaptive cruise control, restoring lane-change assist, or resuming full autonomous driving capability, etc.). When the vehicle encounters an ODD departure event, the processor 130 may enable limp home mode as the vehicle’s mode. Limp home mode is a mode that allows a vehicle to get to a safe location when a problem is detected in the functionality of the autonomous driving system or the vehicle during driving, while preventing the risk of accidents or further damage (e.g., reduced power mode, speed limitation, or minimal braking/steering support, etc.).

For example, the vehicle may be controlled in limp home mode, triggered by an ODD departure event, and when the vehicle enters the ODD after the ODD departure event ends, the processor 130 may perform a control operation for restoring the vehicle’s functionality to normal, including disabling limp home mode and enabling the vehicle to perform autonomous driving (e.g., disengaging limp mode limits, restoring normal throttle response, or resuming automated driving functions, etc.).

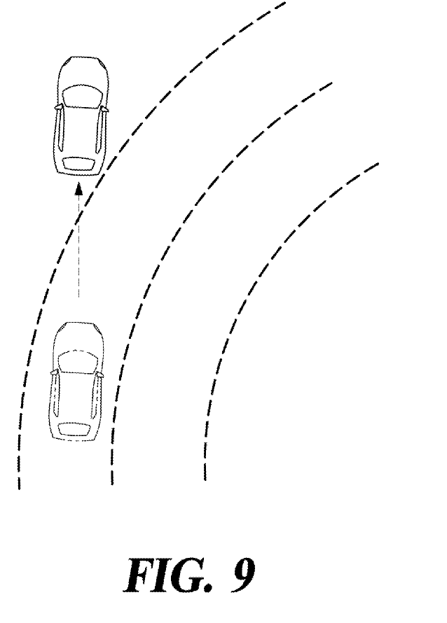

FIG. 9 shows an example of a straight stop according to an example of the present disclosure.

Referring to FIG. 9, a straight stop refers to a maneuver where a vehicle is brought to a halt by performing longitudinal control (e.g., applying braking torque, engine braking, or regenerative braking, etc.). A straight stop does not involve lateral control. That is, a straight stop does not involve a control operation intended to keep the vehicle within the current lane (e.g., steering adjustments, lane centering corrections, or obstacle-avoidance swerves, etc.). A straight stop may be activated when lane markings cannot be detected (e.g., worn paint, snow-covered roads, or faded construction markings, etc.) or lateral control is not available due to a fault in an actuator intended for lateral control (e.g., steering actuator malfunction, sensor misalignment, or loss of power to the lateral control circuit, etc.). The processor 130 may control the vehicle to perform a straight stop (e.g., by executing predefined braking logic and safely decelerating the vehicle until a complete stop is achieved).

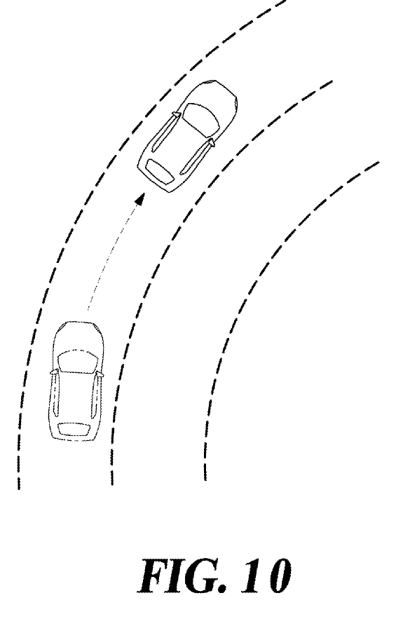

FIG. 10 shows an example of an in-lane stop according to an example of the present disclosure.

Referring to FIG. 10, an in-lane stop refers to a maneuver where a vehicle remains within the current lane until it comes to a stop (e.g., stopping behind a traffic jam, halting at a red light, or pausing in a tunnel, etc.). In an in-lane stop, the vehicle may be controlled both longitudinally (e.g., braking, throttle reduction, or regenerative braking, etc.) and laterally (e.g., steering corrections to maintain lane center, micro-adjustments to avoid lane drift, or compensations for road curvature, etc.). The processor 130 may control the vehicle to perform an in-lane stop (e.g., by coordinating longitudinal and lateral control so that the vehicle decelerates smoothly while staying centered within the lane).

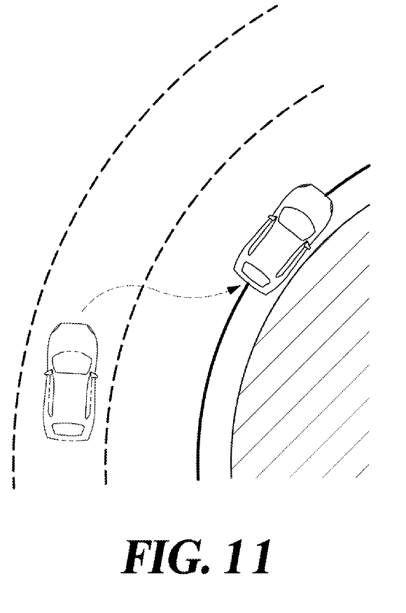

FIG. 11 shows an example of a half-shoulder stop according to an example of the pre sent disclosure.

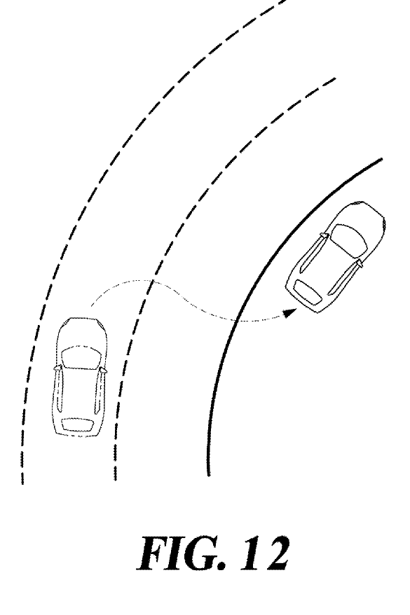

FIG. 12 shows an example of a full-shoulder stop according to an example of the present disclosure.

A shoulder stop refers to a maneuver where a vehicle is brought to a halt on a shoulder area (e.g., highway emergency shoulder, service lane, or breakdown lane, etc.). A shoulder stop may include variations such as a half-shoulder stop and a full-shoulder stop.

Referring to FIG. 11, a half-shoulder stop refers to a maneuver where a vehicle comes to a stop, with part of it occupying a shoulder area. In this case, the rest of the vehicle may be positioned within the driving lane (e.g., the right-side wheels on the shoulder while the left-side wheels remain in the traffic lane, etc.). In a half-shoulder stop, the vehicle may be controlled both longitudinally and laterally (e.g., braking while simultaneously steering partially toward the shoulder, etc.). The processor 130 may control the vehicle to perform a half-shoulder stop (e.g., when there is limited shoulder width or partial obstructions).

Referring to FIG. 12, a full-shoulder stop refers to a maneuver where a vehicle stops entirely within a shoulder area (e.g., pulling completely into an emergency lane, refuge area, or designated lay-by zone, etc.). In a full-shoulder stop, the vehicle may be controlled both longitudinally and laterally (e.g., reducing speed with braking while steering fully onto the shoulder until the vehicle is entirely out of the traffic lane, etc.). The processor 130 may control the vehicle to perform a full-shoulder stop (e.g., when sufficient shoulder space exists for safe clearance from active traffic).

In MRM control, the processor 130 may control the vehicle to perform one of a straight stop, an in-lane stop, a half-shoulder stop, and a full-shoulder stop (e.g., depending on roadway geometry, availability of a safe shoulder, or sensor recognition of lane markings, etc.).

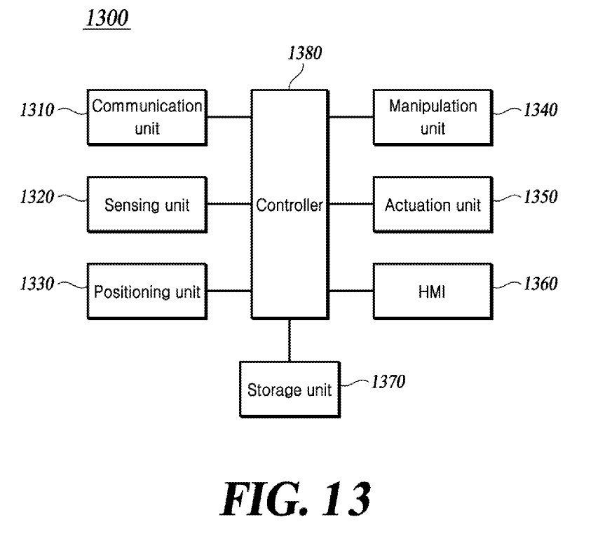

FIG. 13 shows an exemplary vehicle system that can be used to implement a method or apparatus described in the present disclosure.

Referring to FIG. 13, a vehicle 1300 includes at least one of a communication unit 1310, a sensing unit 1320, a positioning unit 1330, a manipulation unit 1340, an actuation unit 1350, an HMI 1360, a storage unit 1370, and a controller 1380. The vehicle 1300 may structurally and/or functionally include an autonomous driving system 100. Here, the vehicle 1300 may correspond to the vehicle explained previously with reference to FIGS. 1 through 12.

The communication unit 1310 may exchange signals with devices positioned outside and inside the vehicle 1390. The communication unit 1310 may exchange signals with at least one of infrastructure equipment such as a server or a base station, other vehicles, and terminals (e.g., smartphones, roadside sensors, or cloud-based traffic servers, etc.). The communication unit 1310 may include at least one of transmit antennas, receive antennas, and RF (Radio Frequency) circuits and RF elements capable of implementing various communication protocols, to perform communication. The communication unit 1310 may include an internal communication unit and an external communication unit. The internal communication unit may send or receive various kinds of data by using various communication protocols present within the vehicle 1300. Here, internal communication protocols may include at least one of CAN (Controller Area Network), CAN FD (CAN with Flexible Data rate), Ethernet, LIN (Local Interconnect Network), and FlexRay (e.g., enabling communication between the powertrain controller, braking controller, and infotainment systems, etc.). The communication protocols may include other protocols for communication between various devices mounted in the vehicle. The external communication unit may communicate with other vehicles, an infrastructure system, a base station, and a roadside unit by using various communication protocols. Here, external communication protocols may include Vehicle-to-Everything (V2X) communication including Vehicle-to-Vehicle (V2V) communication, Vehicle-to-Infrastructure (V2I) communication, Vehicle-to-Network (V2N) communication, and Vehicle-to-Pedestrian (V2P) communication. The infrastructure may be a roadside unit or server that periodically sends out traffic information by interworking with TIS (Transportation Information System) or ITS (Intelligent Transport System) (e.g., congestion alerts, road hazard notifications, or dynamic speed-limit updates, etc.).

The sensing unit 1320 may sense the status of the vehicle 1300 and external objects.

The sensing unit 1320 may include at least one of an IMU (inertial measurement unit), a DMI (Distance Measuring Instrument), a collision sensor, a wheel sensor, a speed sensor, an inclination sensor, a weight sensor, a heading sensor, a position module, a vehicle forward/reverse sensor, a battery sensor, a fuel sensor, a tire sensor, a steering sensor, a temperature sensor, a humidity sensor, an ultrasonic sensor, an illumination sensor, and a pedal position sensor, in order to sense the status of the vehicle 1300 (e.g., monitoring wheel slip, brake pad wear, or ambient temperature, etc.). Meanwhile, IMU (inertial measurement unit) sensors may include one or more of an acceleration sensor, a gyro sensor, and a magnetic sensor. The sensing unit 1320 may generate vehicle status data based on a signal generated by at least one sensor. For example, the sensing unit 1320 may obtain direction information such as the heading, yaw rate, or roll angle, etc. of the vehicle 1300.

The sensing unit 1320 may include at least one of a camera, a radar sensor, a LiDAR (Light Detection and Ranging) sensor, an ultrasonic sensor, and an infrared sensor, in order to sense an external object. The sensing unit 1320 may measure at least one of information on the presence or absence of an object, location information of the object, information on the distance between the vehicle 1300 and the object, and information on the speed of the vehicle 1300 relative to the object (e.g., detecting nearby vehicles, pedestrians, lane boundaries, or roadside obstacles, etc.).

The positioning unit 1330 may generate location data of the vehicle 1300. The positioning unit 1330 may include at least one of GPS (Global Positioning System), DGPS (Differential Global Positioning System), or a GNSS (Global Navigation Satellite System). The positioning unit 1330 may generate location data of the vehicle 1330 based on a signal generated by at least one of GPS, DGPS, or GNSS (e.g., satellite positioning, correction signals, or hybrid positioning, etc.). The positioning unit 1330 may estimate the location of the vehicle 1300 based on radio signals received by the communication unit 1310. The positioning unit 1330 may estimate the current location of the vehicle 1300 based on the previous location of the vehicle 1300, travel distance information, travel time information, speed information, or acceleration information, by using an IMU or a DMI (e.g., dead-reckoning navigation, inertial updates, or odometry corrections, etc.). Meanwhile, the controller 1380 may estimate a path history and predicted path of the vehicle 1300, based on location information of the vehicle 1300 obtained by the positioning unit 1330.

The manipulation unit 1340 receives user input for driving. In manual mode, the vehicle 1300 may be operated based on signals provided by the manipulation unit 1340. The manipulation unit 1340 may include a steering input device such as a steering wheel, an acceleration input device such as an acceleration pedal, and a brake input device such as a brake pedal (e.g., supplemented by shift paddles, touch sliders, or joystick-type interfaces, etc.).

The actuation unit 1350 is a device that electrically controls various vehicle actuators within the vehicle 1300. The actuation unit 1350 may include, for example, a power train actuation controller, a chassis actuation controller, a door/window actuation controller, a safety device actuation controller, a lamp actuation controller, and an air conditioning actuation controller (e.g., electronically controlling braking force distribution, adaptive suspension, or automatic climate adjustments, etc.). The actuation unit 1350 may control the motion of the vehicle 1300 based on an input signal from the manipulation unit 1340 or a control signal from the controller 1380.

The HMI 1360 is a device for communication between the vehicle 1300 and a human (e.g., a passenger in the vehicle 1300 or in other vehicles). The HMI 1360 may receive input from the user and provide the user with information generated from the vehicle 1300. The vehicle 1300 may implement a UI (User Interface) or an UX (User Experience) via the HMI 1360. The HMI 1360 may include an input device such as a touch panel and a microphone and an output device such as a display device and a speaker (e.g., head-up display, haptic feedback pads, or external pedestrian notification speakers, etc.). For example, the HMI 1360 may include an internal display that presents a screen toward the inside of the vehicle and/or an external display that presents a screen toward the outside of the vehicle.

The storage unit 1370 may store a program that allows the controller 1380 to perform a method according to an example of the present disclosure. For example, the program may include a plurality of instructions executable by a processor, and a method according to an example of the present disclosure may be performed as the plurality of instructions are executed by the processor.

The storage unit 1370 may be a single memory or multiple memories. If the storage unit 1370 includes a plurality of memories, the plurality of memories may be physically separated. The storage unit 1370 may include at least one of volatile memory and non-volatile memory. The volatile memory includes SRAM (Static Random Access Memory) or DRAM (Dynamic Random Access Memory), and the non-volatile memory includes flash memory (e.g., NAND flash, NOR flash, or solid-state drives, etc.).

The storage unit 1370 stores map information. The map information may be any one of a navigation map and/or a high-definition map (HD map). The high-definition map may be received in real time from an external device or be stored in advance. The navigation map may include geographical information, road information, lane information, building information, or signal information (e.g., speed limits, one-way restrictions, or traffic signal locations, etc.). The high-definition map may include more detailed data than the navigation map. The high-definition map may include road gradient, road curvatures, sign information, etc., for each road unit. The high-definition map may include lane information, lane boundary information, stop line locations, traffic light locations, signal sequences, or intersection information for each road unit. The high-definition map may include basic road information, surrounding environment information, detailed road environment information, or dynamic road situation information. The detailed road environment information may include static information such as terrain level differences, curvatures, lines, lane centerlines, restriction lines, road boundaries, road centerlines, traffic signs, road markings, road shapes and elevations, and lane widths. The dynamic road situation information may include traffic congestion, accident road sections, roadwork sections, and so on (e.g., real-time hazard alerts, live rerouting updates, or predictive congestion patterns, etc.). The high-definition map may include 3D-rendered information on the surrounding environment of a road, geometric information such as road shapes or road facility structures, and semantic information such as traffic signs and/or lane markings.

The controller 1380 may include at least one core capable of executing at least one instruction. The controller 1380 may execute the instructions stored in the storage unit 1370. The controller 1380 may be a single processor or a plurality of processors (e.g., multi-core CPU, GPU-based acceleration, or dedicated AI coprocessors, etc.).

Each component of the apparatus or method according to the present disclosure may be implemented in hardware or software, or may be implemented in a combination of hardware and software. In addition, the function of each component may be implemented in software, and a microprocessor may be used to execute the function of the software corresponding to each component.

Various implementations of the systems and techniques described herein may be realized in digital electronic circuits, integrated circuits, field-programmable gate arrays (FPGAs), application-specific integrated circuits (ASICs), computer hardware, firmware, software, and/or combinations thereof. These various implementations may include implementations in one or more computer programs executable on a programmable system. The programmable system includes at least one programmable processor (which may be a special-purpose processor or may be a general-purpose processor) coupled to receive data and instructions from, and to transmit data and instructions to, a storage system, at least one input device, and at least one output device. The computer programs (also known as programs, software, software applications or code) include instructions for a programmable processor and are stored on a “computer-readable recording medium.”

The computer-readable recording medium includes all kinds of recording devices in which data readable by a computer system is stored. Such a computer-readable recording medium may be a non-volatile or non-transitory medium such as a ROM, a CD-ROM, a magnetic tape, a floppy disk, a memory card, a hard disk, a magneto-optical disk, or a storage device, and may further include a transitory medium such as a data transmission medium. In addition, the computer-readable recording medium may be distributed in a network-connected computer system, and the computer-readable code may be stored and executed in a distributed manner.

Although each process is described as being executed sequentially in the flowchart/timing diagram of the present disclosure, this is merely an illustrative explanation of the technical idea of an example of the present disclosure. In other words, the flowcharts/timing diagrams are not limited to a chronological order, as those of ordinary skill in the art may make various modifications and variations to the flowchart/timing diagram by changing the order described or by executing one or more processes in parallel without departing from the essential characteristics of an example of the present disclosure.

The above description is merely illustrative of the technical idea of the example, and various modifications and variations may be made by those skilled in the art to which the example pertains without departing from the essential characteristics of the example. Therefore, the examples are not intended to limit the technical idea of the example, but are intended to be illustrative, and the scope of the technical idea of the example is not limited by these examples. The protection scope of the example should be construed according to the following claims, and all technical ideas within the scope equivalent thereto are to be construed as being included in the scope of rights of the example.

What is claimed is:

1. A method performed by an apparatus of a vehicle, the method comprising:
obtaining, from a sensor of the vehicle, information on the vehicle and a surrounding environment of the vehicle;
identifying an operational design domain (ODD) departure event of the vehicle based on the information, wherein the ODD corresponds to a set of operating conditions under which autonomous driving of the vehicle is designed to function;
determining a type of the ODD departure event, based on at least one of a location associated with the ODD departure event or a predictability of the ODD departure event; and
controlling, based on the type of the ODD departure event, driving of the vehicle.

2. The method of claim 1, further comprising:
determining a degree of risk associated with the ODD departure event, based on at least one of the type of the ODD departure event or whether or not the ODD departure event is predictable.

3. The method of claim 2, wherein:
based on the ODD departure event being predictable, the degree of risk is determined based on at least one of a remaining distance for the vehicle to reach the location, a remaining time for the vehicle to reach the location, or presence or absence of a safety zone within a threshold distance from the location, and
based on the ODD departure event not being predictable, the degree of risk is determined based on at least one of an intensity of the ODD departure event, a duration of the ODD departure event, or a frequency of the ODD departure event.

4. The method of claim 1, further comprising:
determining a degree of risk associated with the ODD departure event, based on the type of the ODD departure event,
wherein the controlling of driving of the vehicle comprises, based on the degree of risk, performing at least one of:
a control operation for limiting driving performance of the vehicle,
a control operation for requesting a passenger to perform dynamic driving task (DDT), or
a minimal risk maneuver (MRM) control operation.

5. The method of claim 4, wherein, based on the degree of risk being lower than a risk threshold value and based on at least one of a remaining time for the vehicle to reach the location being equal to or greater than a time threshold value or a remaining distance for the vehicle to reach the location being equal to or greater than a distance threshold value, the control operation for limiting the driving performance of the vehicle is performed.

6. The method of claim 4, wherein, based on at least one of the degree of risk being higher than a risk threshold value, a remaining time for the vehicle to reach the location being less than a time threshold value, or a remaining distance for the vehicle to reach the location being less than a distance threshold value, at least one of the control operation for requesting the passenger to perform the DDT or the MRM control operation is performed.

7. The method of claim 4, wherein, the control operation for limiting the driving performance of the vehicle comprises at least one of:
a control operation for limiting a maximum speed of the vehicle,
a control operation for limiting a maximum revolutions per minute (RPM) of the vehicle, or
a control operation for limiting low-level autonomous driving functions of the vehicle.

8. The method of claim 1, wherein the type of the ODD departure event comprises:
a first type which occurs at a fixed location and is predictable;
a second type which occurs at a fixed location and is not predictable;
a third type which occurs at an unfixed location and is not predictable; and
a fourth type which occurs at an unfixed location and is predictable.

9. The method of claim 1, further comprising:
determining a degree of risk associated with the ODD departure event,
wherein the type of the ODD departure event comprises a first type which occurs at a fixed location and is predictable, and
wherein, based on the ODD departure event corresponding to the first type, the degree of risk is determined as low before the vehicle has reached the fixed location and determined as high after the vehicle has reached the fixed location.

10. The method of claim 9, wherein:
based on the degree of risk being determined as low, the controlling of driving of the vehicle comprises performing a control operation for requesting a passenger to perform dynamic driving task (DDT), and
based on the degree of risk being determined as high, the controlling of driving of the vehicle comprises performing shoulder stop control using a minimal risk maneuver (MRM).

11. The method of claim 1, further comprising:
determining a degree of risk associated with the ODD departure event,
wherein the type of the ODD departure event comprises a second type which occurs at a fixed location and is not predictable, and
wherein, based on the ODD departure event corresponding to the second type, the degree of risk is determined based on at least one of:
a perception failure rate associated with recognizing the surrounding environment of the vehicle,
a control error rate associated with deviations between a target driving status of the vehicle and an actual driving status of the vehicle, or
a duration of the ODD departure event.

12. The method of claim 11, wherein, based on the ODD departure event corresponding to the second type,
the degree of risk is determined as low based on the perception failure rate, the control error rate, and the duration being within respective threshold limits,
the degree of risk is determined as intermediary based on one of the perception failure rate, the control error rate, or the duration exceeding the respective threshold limits, and
the degree of risk is determined as high based on at least two of the perception failure rate, the control error rate, and the duration exceeding the respective threshold limits.

13. The method of claim 12, wherein:
based on the degree of risk being determined as low or intermediary, the controlling of driving of the vehicle comprises performing at least one of a control operation for requesting a passenger to perform dynamic driving task (DDT) and a control operation for limiting driving performance of the vehicle, and
based on the degree of risk being determined as high, the controlling of the vehicle comprises performing an in-lane stop control or a straight stop control using a minimal risk maneuver (MRM).

14. The method of claim 1, further comprising:
determining a degree of risk associated with the ODD departure event,
wherein the type of the ODD departure event comprises a third type which occurs at an unfixed location and is not predictable,
wherein, based on the ODD departure event corresponding to the third type, the degree of risk is determined based on at least one of:
a perception failure rate associated with recognizing the surrounding environment of the vehicle,
a control error rate associated with deviations between a target driving status of the vehicle and an actual driving status of the vehicle,
a duration of the ODD departure event, or
a frequency of the ODD departure event.

15. The method of claim 14, wherein, based on the ODD departure event corresponding to the third type,
the degree of risk is determined as low based on the perception failure rate, the control error rate, the duration, and the frequency being within respective threshold limits,
the degree of risk is determined as intermediary based on one of the perception failure rate, the control error rate, the duration, or the frequency exceeding the respective threshold limits, and
the degree of risk is determined as high based on at least two of the perception failure rate, the control error rate, the duration, or the frequency exceeding the respective threshold limits.

16. The method of claim 15, wherein:
based on the degree of risk being determined as low or intermediary, the controlling of driving of the vehicle comprises performing at least one of a control operation for requesting a passenger to perform dynamic driving task (DDT) and a control operation for limiting driving performance of the vehicle, and
based on the degree of risk being determined as high, the controlling of driving of the vehicle comprises performing an in-lane stop control or a straight stop control using a minimal risk maneuver (MRM).

17. The method of claim 1, further comprising:
determining a degree of risk associated with the ODD departure event,
wherein the type of the ODD departure event comprises a fourth type which occurs at an unfixed location and is predictable,
wherein, based on the ODD departure event corresponding to the fourth type, the degree of risk is determined as low before the vehicle has reached the unfixed location and determined as high after the vehicle has reached the unfixed location.

18. The method of claim 17, wherein:
based on the degree of risk being determined as low, the controlling of driving of the vehicle comprises performing a control operation for requesting a passenger to perform dynamic driving task (DDT), and
based on the degree of risk being determined as high, the controlling of driving of the vehicle comprises performing a shoulder stop control or an in-lane stop control using a minimal risk maneuver (MRM).

19. The method of claim 1, further comprising, based on the ODD departure event ending, discontinuing a control operation for limiting driving performance of the vehicle which was triggered by the ODD departure event, and restoring the driving performance of the vehicle.

20. A vehicle comprising:
a sensor;
a driving control circuit configured to control autonomous driving of the vehicle; and
a processor circuit configured to:
obtain, based on data from the sensor, information on the vehicle and a surrounding environment of the vehicle,
identify an operational design domain (ODD) departure event corresponding to an event that causes or is expected to cause the vehicle or the surrounding environment to fall outside the ODD, wherein the ODD corresponds to a set of operating conditions under which autonomous driving of the vehicle is designed to function,
based on at least one of a location associated with the ODD departure event or a predictability of the ODD departure event, determine a type of the ODD departure event,
determine, based on the type of the ODD departure event, a degree of risk associated with the ODD departure event, and
control, via the driving control circuit and based on the degree of risk, driving of the vehicle by performing at least one of requesting driver takeover, adjusting a level of autonomous driving, or executing a minimal risk maneuver.
